(19) United States
(12) Patent Application Publication
(10) Pub. No.: US 2025/0149213 A1
(43) Pub. Date: May 8, 2025

(54) FEEDSTOCK FOR PREPARING NdFeB FLEXIBLE MAGNET, AND NdFeB FLEXIBLE MAGNET AND PREPARATION METHOD AND USE THEREOF

(71) Applicant: BEIJING ZHONG KE SAN HUAN HI-TECH CO., LTD., Beijing (CN)

(72) Inventors: Shulei CHEN, Beijing (CN); Shuai WANG, Beijing (CN); Guochao QIN, Beijing (CN); Daoyan CAI, Beijing (CN); Zhan WANG, Beijing (CN)

(21) Appl. No.: 18/927,399

(22) Filed: Oct. 25, 2024

(30) Foreign Application Priority Data
Nov. 8, 2023 (CN) 202311475070.8

(51) Int. Cl. H01F 1/057; B22F 1/102; C22C 38/00; H01F 41/02

(52) U.S. Cl. CPC H01F 1/0571; B22F 1/102; H01F 41/0266; B22F 2301/355; B22F 2304/10; C22C 38/005; C22C 2202/02

(57) ABSTRACT

A neodymium-iron-boron flexible magnet includes 93.5 wt % to 94.6 wt % of neodymium-iron-boron magnetic powder, 0.3 wt % to 0.5 wt % of surface treatment agent for magnetic powder, 2.7 wt % to 3.7 wt % of binder, 0.3 wt % to 1.0 wt % of antioxidant, and 0.5 wt % to 1.8 wt % of plasticizer. The binder includes type I thermoplastic elastomer and type II thermoplastic elastomer, with a mass ratio of the type I thermoplastic elastomer to the type II thermoplastic elastomer being 1:9 to 4:6. The type I thermoplastic elastomer is selected from one or more of thermoplastic polyamide elastomer and thermoplastic polyurethane elastomer; and the type II thermoplastic elastomer is selected from one or more of styrenic block copolymers, dynamically vulcanized thermoplastic elastomers, thermoplastic polyolefin elastomers, and thermoplastic polyester elastomers.

### CROSS-REFERENCE TO RELATED APPLICATION

This application claims priority to Chinese Application No. 202311475070.8, filed on Nov. 8, 2023, the entire content of which is incorporated herein by reference.

### TECHNICAL FIELD

The present disclosure relates to the technical field of motors, and in particular, to feedstock for preparing NdFeB flexible magnet, and NdFeB flexible magnet and preparation method and use thereof.

### BACKGROUND

Magnetic materials are widely used functional materials that play an important role in the development and progress of human society. Flexible bonded rare earth magnets are products of bonded rare earth magnets that exhibit good flexibility, allowing them to be bent without cracking. These products have adjustable dimensions and small thickness, making them convenient for assembly and use. They meet the demands of consumer electronics or micro motors for miniaturization, ultra-thin designs, high speed, and high precision, indicating a promising market outlook.

Currently, flexible magnetic materials are primarily produced using rubber as a binder through a rolling process. The preparation of conventional rubber magnets involves several complex steps, including open mixing, internal mixing, rolling, and molding (vulcanization). Injection molding magnets are a processing method that combines plastic or rubber with magnetic powder to create feedstock, which is then plasticized and injected into the cavity of a closed mold using a plunger or reciprocating screw to form the final product. The injection molding method can produce parts with complex shapes, precise dimensions, or embedded components.

Currently, there is limited research on the injection molding technology for preparing high magnetic performance flexible magnets. This is primarily due to the requirement for a high magnetic powder filling ratio to meet the magnetic performance standards of the magnets. However, the injection molding process demands higher flowability of the feedstock. When the magnetic powder content is high, the amount of binder is correspondingly reduced, which negatively impacts the flowability of the feedstock. This can lead to insufficient mold filling and result in defects in the final products.

Based on this, CN111667967A discloses a high-flowability samarium-iron-nitrogen flexible bonded permanent magnet for injection molding and its preparation method. The method involves mixing rubber-based binders such as chlorinated polyethylene, polyvinyl chloride, and thermoplastic polyurethane elastomers with samarium-iron-nitrogen magnetic powder and additives, followed by internal mixing, calendering, and pelletizing to form feedstock. The feedstock is then molded in an injection molding machine to produce high-performance flexible magnets. However, the samarium-iron-nitrogen powder has a finer particle size compared to neodymium-iron-boron (NdFeB) powder, making it more prone to oxidation. Additionally, the complex preparation process and low production efficiency of this study pose challenges for mass production.

### SUMMARY

To address the aforementioned shortcomings in this field, the present application aims to provide feedstock for preparing NdFeB flexible magnet, as well as the NdFeB flexible magnets, their preparation methods, and applications. This solution offers a rational combination and synergistic use of magnetic powder, resin, and additives to enhance the flowability of the granulated material while achieving a balance between the magnetic performance requirements and flexibility of the magnets.

The first aspect of the disclosure provides a NdFeB flexible magnet, which is prepared from the following raw materials which comprises a content of neodymium-iron-boron magnetic powder in a range from 93.5 wt % to 94.6 wt %, a content of surface treatment agent for magnetic powder in a range from 0.3 wt % to 0.5 wt %, a content of binder in a range from 2.7 wt % to 3.7 wt %, a content of antioxidant in a range from 0.3 wt % to 1.0 wt %, a content of plasticizer in a range from 0.5 wt % to 1.8 wt %;
wherein, the binder is a blend of type I thermoplastic elastomer (also referred to as “first type thermoplastic elastomer”) and type II thermoplastic elastomer (also referred to as “second type thermoplastic elastomer”), with a mass ratio of type I to type II being 1:9 to 4:6,
type I thermoplastic elastomer is selected from one or more of the following: thermoplastic polyamide elastomer and thermoplastic polyurethane elastomer,
type II thermoplastic elastomer is selected from one or more of the following: styrenic block copolymers, dynamically vulcanized thermoplastic elastomers, thermoplastic polyolefin elastomers, and thermoplastic polyester elastomers.

The styrenic block copolymers include, but are not limited to, polystyrene-polybutadiene-polystyrene block copolymer, polystyrene-poly(ethylene-butylene)-polystyrene block copolymer, polystyrene-poly(ethylene-propylene)-polystyrene block copolymer, and polystyrene-polyisoprene-polystyrene block copolymer.

The dynamically vulcanized thermoplastic elastomers include, but are not limited to, blends of ethylene-propylene rubber and polypropylene, blends of nitrile rubber and polypropylene or blends of diene rubber and thermoplastic vulcanizates of polyolefin.

In some embodiments, the neodymium-iron-boron magnetic powder has a large particle size with D50 in a range from 50 μm to 100 μm.

In some embodiments, the neodymium-iron-boron magnetic powder comprises a content of rare earth metal elements R in a range from 20 wt % to 26 wt %, a content of M in a range from 0 wt % to 2.5 wt %, a content of Co in a range from 0 wt % to 5 wt %, a content of B in a range from 0.98 wt % to 1.1 wt %, with the content of Fe as the remainder; wherein M is a transition metal element other than Fe and Co; in some embodiments, M is one or more selected from Cu, Zr, Nb, Ti, Cr, V, Mo, and W.

In some embodiments, the neodymium-iron-boron magnetic powder needs to be used in conjunction with compound magnetic powder; in some embodiments, the compound magnetic powder has a small particle size with D50 in a range from 2 μm to 20 μm; in some embodiments, the small particle size magnetic powder is selected from: NdFeB compound magnetic powder, SmFeN compound magnetic powder, or ferrite compound powder, and in some embodiments the small particle size magnetic powder is NdFeB magnetic powder.

In some embodiments, the mass ratio of the neodymium-iron-boron magnetic powder to the compound magnetic powder is in a range from 9:1 to 7:3.

In some embodiments, the NdFeB compound magnetic powder includes: a content of rare earth metal elements R in a range from 20 wt % to 26 wt %, a content of M in a range from 0 wt % to 2.5 wt %, a content of Co in a range from 0 wt % to 5 wt %, a content of B in a range from 0.98 wt % to 1.1 wt %, with the content of Fe as the remainder; wherein M is a transition metal element other than Fe and Co; in some embodiments, M is one or more selected from Cu, Zr, Nb, Ti, Cr, V, Mo, and W.

In some embodiments, the type I thermoplastic elastomer is a thermoplastic polyurethane elastomer; the type II thermoplastic elastomer is a thermoplastic polyester elastomer.

In some embodiments, the surface treatment agent for the magnetic powder is selected from one or more of silane coupling agents, titanate coupling agents, aluminate coupling agents, phosphates, phosphonates, and nano-silica; in some embodiments, it is a silane coupling agent or a titanate coupling agent.

In some embodiments, the plasticizer is one or more selected from natural wax, synthetic wax, fatty acid metal salts, silicon dioxide compounds, polysiloxanes, fluoroplastics, epoxidized soybean oil, silicone oil, phthalates, phosphate esters, adipate esters, sebacic esters, and decanoate esters, citrate esters, trimellitate esters, halogenated hydrocarbons, benzoate esters, fatty acid esters, pentaerythritol, epoxidized fatty esters, and polyesters; in some embodiments, wherein the phthalate includes dioctyl phthalate, the adipate ester includes dioctyl adipate; in some embodiments, the plasticizer is one or more selected from synthetic wax, silicone oil, epoxidized soybean oil, dioctyl phthalate, dioctyl adipate.

In some embodiments, the antioxidant is one or more selected from hindered amine antioxidants, hindered phenolic antioxidants, phosphites or thioesters. In some embodiments, the hindered phenolic antioxidants include N,N′-bis(3-(3,5-di-tert-butyl-4-hydroxyphenyl)propionyl)hydrazine or tetra(β(3,5-di-tert-butyl-4-hydroxyphenyl)propionic acid) pentaerythritol ester.

In some embodiments, the maximum magnetic energy product of the neodymium-iron-boron flexible magnet is equal to or greater than 7.5 MGOe, in some embodiments the maximum magnetic energy product is in a range from 8.0 MGOe to 9.0 MGOe.

The second aspect of the disclosure provides feedstock for preparing NdFeB flexible magnet, which comprises a content of neodymium-iron-boron magnetic powder in a range from 93.5 wt % to 94.6 wt %, a content of surface treatment agent for magnetic powder in a range from 0.3 wt % to 0.5 wt %, a content of binder in a range from 2.7 wt % to 3.7 wt %, a content of antioxidant in a range from 0.3 wt % to 1.0 wt %, a content of plasticizer in a range from 0.5 wt % to 1.8 wt %;
wherein, the binder is a blend of type I thermoplastic elastomer and type II thermoplastic elastomer, with a mass ratio of type I to type II in a range of 1:9 to 4:6,
type I thermoplastic elastomer is selected from one or more of the following: thermoplastic polyamide elastomer and thermoplastic polyurethane elastomer,
type II thermoplastic elastomer is selected from one or more of the following: styrenic block copolymers, dynamically vulcanized thermoplastic elastomers, thermoplastic polyolefin elastomers, and thermoplastic polyester elastomers.

The melt volume rate (MVR) of the feedstock under a load of 10 kg at 170° C. is in a range from 15 cm³/10 min to 65 cm³/10 min, and the melt flow rate (MFR) is in a range from 80 g/10 min to 350 g/10 min; in some embodiments, the MVR is in a range from 15 cm³/10 min to 55 cm³/10 min, and the MFR is in a range from 80 g/10 min to 300 g/10 min.

The styrenic block copolymers include, but are not limited to, polystyrene-polybutadiene-polystyrene block copolymer, polystyrene-poly(ethylene-butylene)-polystyrene block copolymer, polystyrene-poly(ethylene-propylene)-polystyrene block copolymer, and polystyrene-polyisoprene-polystyrene block copolymer.

The dynamically vulcanized thermoplastic elastomers include, but are not limited to, blends of ethylene-propylene rubber and polypropylene, blends of nitrile rubber and polypropylene or blends of diene rubber and thermoplastic vulcanizates of polyolefin.

In some embodiments, the neodymium-iron-boron magnetic powder has a large particle size with D50 in a range from 50 μm to 100 μm. In some embodiments, the neodymium-iron-boron magnetic powder comprises a content of rare earth metal elements R in a range from 20 wt % to 26 wt %, a content of M in a range from 0 wt % to 2.5 wt %, a content of Co in a range from 0 wt % to 5 wt %, a content of B in a range from 0.98 wt % to 1.1 wt %, with the content of Fe as the remainder; wherein M is a transition metal element other than Fe and Co; in some embodiments, M is one or more selected from Cu, Zr, Nb, Ti, Cr, V, Mo, and W.

In some embodiments, the neodymium-iron-boron magnetic powder needs to be used in conjunction with compound magnetic powder; in some embodiments, the compound magnetic powder has a small particle size with D50 in a range from 2 μm to 20 μm; in some embodiments, the small particle size magnetic powder is selected from: NdFeB compound magnetic powder, SmFeN compound magnetic powder, or ferrite compound powder. In some embodiments, the small particle size magnetic powder is NdFeB compound magnetic powder.

In some embodiments, the mass ratio of the neodymium-iron-boron magnetic powder to the compound magnetic powder is in a range from 9:1 to 7:3.

In some embodiments, the NdFeB compound magnetic powder includes: a content of rare earth metal elements R in a range from 20 wt % to 26 wt %, a content of M in a range from 0 wt % to 2.5 wt %, a content of Co in a range from 0 wt % to 5 wt %, a content of B in a range from 0.98 wt % to 1.1 wt %, with the content of Fe as the remainder; where M is a transition metal element other than Fe and Co; in some embodiments, M is one or more selected from Cu, Zr, Nb, Ti, Cr, V, Mo, and W.

In some embodiments, the type I thermoplastic elastomer is a thermoplastic polyurethane elastomer; the type II thermoplastic elastomer is a thermoplastic polyester elastomer.

In some embodiments, the surface treatment agent for the magnetic powder is selected from one or more of silane coupling agents, titanate coupling agents, aluminate coupling agents, phosphates, phosphonates, and nano-silica; in some embodiments, it is a silane coupling agent or a titanate coupling agent.

In some embodiments, the plasticizer is one or more selected from natural wax, synthetic wax, fatty acid metal salts, silicon dioxide compounds, polysiloxanes, fluoroplastics, epoxidized soybean oil, silicone oil, phthalates, phosphate esters, adipate esters, sebacic esters, and decanoate esters, citrate esters, trimellitate esters, halogenated hydrocarbons, benzoate esters, fatty acid esters, pentaerythritol, epoxidized fatty esters, and polyesters; in some embodiments, wherein the phthalate includes dioctyl phthalate, the adipate ester includes dioctyl adipate; in some embodiments, the plasticizer is one or more selected from synthetic wax, silicone oil, epoxidized soybean oil, dioctyl phthalate, dioctyl adipate.

In some embodiments, the antioxidant is one or more selected from hindered amine antioxidants, hindered phenolic antioxidants, phosphites or thioesters. In some embodiments, the hindered phenolic antioxidants include N,N′-bis(3-(3,5-di-tert-butyl-4-hydroxyphenyl)propionyl)hydrazine or tetra(β(3,5-di-tert-butyl-4-hydroxyphenyl)propionic acid) pentaerythritol ester.

The third aspect of the present disclosure provides a method for preparing NdFeB flexible magnet, comprising:
surface treating and drying the neodymium-iron-boron magnetic powder to obtain dried neodymium-iron-boron magnetic powder;
uniformly mixing the dried neodymium-iron-boron magnetic powder with the binder, antioxidant, and plasticizer to obtain a mixed powder;
performing raw material mixing to obtain feedstock, which is then injection molded to produce the neodymium-iron-boron flexible magnet.
wherein, the binder is a blend of type I thermoplastic elastomer and type II thermoplastic elastomer, with a mass ratio of type I to type II in a range of 1:9 to 4:6,
type I thermoplastic elastomer is selected from one or more of the following: thermoplastic polyamide elastomer and thermoplastic polyurethane elastomer,
type II thermoplastic elastomer is selected from one or more of the following: styrenic block copolymers, dynamically vulcanized thermoplastic elastomers, thermoplastic polyolefin elastomers, and thermoplastic polyester elastomers.

In some embodiments, the raw material mixing preparation by using twin-screw extruder which is equipped with 9 mixing sections and the mixing temperature is set at in a range of 140° C. to 170° C.

In some embodiments, the injection molding machine used for injection molding is equipped with 5 temperature zones, and the injection temperature is set at in a range of 170° C. to 190° C.

The fourth aspect of the present disclosure provides the neodymium-iron-boron flexible magnets which are applied in product fields such as 3C (computer, communication, consumer electronics), automotive, drones, and aerospace.

Compared to the related art, the advantages of the present disclosure will be set forth.

The present disclosure provides a neodymium-iron-boron flexible magnet and the feedstock for its preparation. By adopting a dual-component magnetic powder and dual-component resin approach, a high magnetic powder filling ratio is achieved along with high fluidity. It successfully produces injection-moldable flexible magnet feedstock with a melt flow index (MVR) in a range of 15 cm³/10 min to 65 cm³/10 min and a melt flow rate (MFR) in a range of 80 g/10 min to 350 g/10 min (tested at 170° C. with a load of 10 kg). Based on this feedstock, a high-performance injection-molded flexible magnet with a maximum magnetic energy product (BH)max in a range of 7.5 MGOe to 9.0 MGOe is fabricated.

The neodymium-iron-boron flexible magnet of the present disclosure can meet both high magnetic performance requirements and high flexibility. With the component ratios specified in the present disclosure, injection molding methods can be used to produce flexible magnets with high filling density and good flexibility.

### BRIEF DESCRIPTION OF THE DRAWINGS

FIG. 1 is a schematic diagram of the preparation process for the neodymium-iron-boron flexible magnet in the exemplary embodiment of this application.

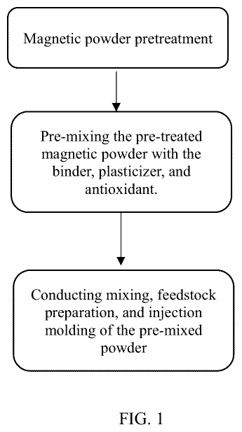

### DETAILED DESCRIPTION OF EMBODIMENTS

The following will provide a clear and complete description of the technical solutions of the present disclosure in conjunction with the embodiments. It is evident that the described embodiments are part of the various embodiments of the present disclosure, not all of them. All other embodiments that those skilled in the art may derive without making any creative effort are included within the scope of the present disclosure.

It is particularly noteworthy that similar substitutions and modifications made regarding the present disclosure are apparent to those skilled in the art, and they are considered to be included in the present disclosure. Relevant personnel can clearly make alterations, appropriate changes, or combinations to the methods and applications described herein without deviating from the content, spirit, and scope of the present disclosure to realize and apply the technology of the present disclosure. It is clear that the described embodiments are merely a portion of the embodiments of the present disclosure, not all of them.

Unless specific conditions are stated in the present disclosure, all processes are conducted under conventional conditions or conditions recommended by the manufacturer. The raw materials or excipients used, as well as reagents or instruments not specified with manufacturers, are all conventional products that can be obtained commercially.

The following provides a detailed explanation of the present disclosure.

CN101783219, by Applicant of the present application, discloses a method for preparing flexible bonded rare earth permanent magnets. This method involves uniformly mixing NdFeB magnetic powder, a binder made of thermoplastic elastomer with engineering plastic properties, and processing aids. The flexible bonded magnets are then produced using injection molding, calendering, or extrusion processes. The mixing methods include high-speed mixing, internal mixing, open mixing, and twin-screw mixing. Based on this, it discloses that the magnetic powder filling ratio for magnets produced by injection molding is lower compared to that for magnets produced by calendering or extrusion. Through multiple experimental validations, it was discovered that the maximum magnetic powder filling ratio for conventional injection molding processes is 92.1 wt %, while the maximum filling ratios for the other two processes are 95.5 wt % and 96.5 wt %, respectively.

Further analysis indicates that an increase in the magnetic powder filling ratio leads to a decrease in the flexibility (or tensile strength) of the magnet, as well as a reduction in the flowability of the feedstock. The injection-molded magnets have strict requirements for the flowability of the feedstock and insufficient flowability can result in issues such as difficulty in filling the mold, sticking to the mold, and uneven performance distribution of the products. Therefore, it is essential to improve the flowability of the feedstock.

Consequently, there is a need to further increase the magnetic powder filling ratio in injection-molded flexible magnets without compromising flexibility requirements. This necessitates exploring the reasonable combination and synergistic use of magnetic powder, resin, or additives to find a balance between magnetic performance and flexibility performance.

The present disclosure selects thermoplastic elastomer (hereinafter referred to as TPE) as the binder, with an optional blend of type I TPE resin and type II TPE resin to improve the magnetic powder filling ratio and the flowability of the feedstock.

Selection of raw materials for the feedstock in the present disclosure is as follows.

The magnetic powder has a content in a range of 93.5 wt % to 94.6 wt %, which involves a single main magnetic powder system or a combination system of main magnetic powder and compound magnetic powder. The main magnetic powder with large particle size is selected from isotropic NdFeB powder or anisotropic NdFeB powder (including but not limited to HDDR powder), wherein the composition of the NdFeB powder is as follows: the content of R is in a range of 20 wt % to 26 wt %, the content of M is in a range of 0 wt % to 2.5 wt %, the content of Co is in a range of 0 wt % to 5 wt %, the content of B is in a range of 0.98-1.1, with the content of Fe as the remainder. The average particle size D50 of the NdFeB powder is in a range of 50 μm to 100 μm. The compound magnetic powder is selected one from NdFeB magnetic powder, SmFeN magnetic powder, ferrite powder, with the average particle size D50 in a range from 2 m to 20 μm. The mass ratio of the main magnetic powder to the compound magnetic powder is in a range from 9:1 to 7:3.

The binder (TPE) has a content in a range of 2.7 wt % to 3.7 wt %, which is a blend of type I (TPE) and type II (TPE) to use, with a mass ratio of type I to type II being 1:9 to 4:6.

The surface treatment agent for the magnetic powder has a content in a range of 0.3 wt % to 0.5 wt %. The surface treatment can couple the surface treatment agent with the magnetic powder, allowing the magnetic powder to be coated by the surface treatment agent, thereby reducing oxidation of the magnetic powder.

The plasticizer has a content in a range of 0.5 wt % to 1.8 wt %, to improve the flexibility of the magnet and the flowability of the powder while ensuring strength. It can include natural wax, synthetic wax, metal salts of fatty acids, silica compounds, polysiloxanes, fluoroplastics, epoxidized soybean oil, silicone oil, phthalates (especially dioctyl phthalate), phosphates, adipate (especially dioctyl adipate), sebacate, and decanoate, citrate, trimellitate, halogenated hydrocarbons, benzoates, fatty acid esters (including oleate, stearate, ricinoleate, etc.), pentaerythritol, epoxidized fatty esters, polyesters, and certain polycondensates. In some embodiments, the plasticizer includes one or more of synthetic wax, silicone oil, epoxidized soybean oil, dioctyl phthalate, and dioctyl adipate in a blended system.

The antioxidant has a content in a range of 0.3 wt % to 1.0 wt %, to reduce the thermal decomposition of the resin and mitigate the corrosive effects of resin decomposition products on the magnetic powder. In some embodiments, the antioxidant includes one or more of hindered amines, hindered phenols (such as butylated hydroxytoluene (BHT) or 2,6-di-tert-butyl-4-methylphenol). In some embodiments, the antioxidant includes one or more of N,N′-bis(3-(3,5-di-tert-butyl-4-hydroxyphenyl)propionyl) hydrazine or tetrakis(β-(3,5-di-tert-butyl-4-hydroxyphenyl)propionate) pentaerythritol ester, phosphites, thioesters.

The preparation process of the feedstock is as follows.

Preparing magnetic powder by using a rapid quenching process and crushing with a double-roll crusher.

Surface treating the magnetic powder with at least one of the following: silane coupling agents, titanate coupling agents, or phosphate coupling agents.

Premixing the above magnetic powder in powder form with resin (binder) and other additives using a high-speed mixer.

Mixing and preparing the feedstock by using the magnetic powder, resin, and additives with a twin-screw extruder that has 9 mixing sections, with a maximum temperature of 170° C. and a minimum temperature of 140° C. during the process.

Subjecting the feedstock obtained from preparing feedstock to injection molding, using an injection molding machine that has 5 temperature zones, with a maximum temperature of 190° C. and a minimum temperature of 170° C.

The following further explains the technical solutions of this application in conjunction with the implementation examples.

The characteristic parameters of the neodymium-iron-boron magnetic powder used in the examples and comparative examples are shown in Table 1.

TABLE 1

| | | Large particle | Small particle |
|---|---|---|---|
| | | NdFeB magnetic | NdFeB magnetic |
| Characteristic parameters | Unit | powder | powder |
| Remanence (Br) | Gs | 9077 | 8700 |
| Coercivity (Hcb) | Oe | 7273 | 6600 |
| Intrinsic coercivity (Hcj) | Oe | 9955 | 9800 |
| Maximum magnetic | MGOe | 17.4 | 14.8 |
| energy product ((BH)ₘₐₓ) | | | |
| Average particle size | μm | 57.79 | 4.53 |
| D50 | | | |

### Example I

Preparation process of the NdFeB flexible magnet in the present disclosure is as follow.

Magnetic powder pretreatment: surface treatment of 94.00 wt % large particle NdFeB magnetic powder with 0.28 wt % silane coupling agent, followed by drying the solvent to obtain dried magnetic powder.

Mixing: the dried magnetic powder is mixed uniformly at room temperature with 2.74 wt % thermoplastic polyester elastomer, 0.68 wt % thermoplastic polyurethane elastomer, 0.50 wt % tetrakis(β(3,5-di-tert-butyl-4-hydroxyphenyl) propionate) pentaerythritol ester, 0.30 wt % wax emulsion, 0.50 wt % epoxy soybean oil, and 1.00 wt % dioctyl adipate using a high-speed mixer to obtain a mixed powder.

Preparation of feedstock: the mixed powder is mixed and pelletized by using a twin-screw extruder, which includes 9 mixing sections, with a maximum mixing temperature of 170° C. and a minimum mixing temperature of 140° C., to obtain feedstock for injection molding.

Injection Molding: the feedstock is injected molded using an injection molding machine, which has 5 temperature zones, with a maximum temperature of 190° C. and a minimum temperature of 170° C.

### Example II

Preparation process of the NdFeB flexible magnet in the present disclosure is as follow.

Magnetic powder pretreatment: surface treatment of 84.60 wt % large particle NdFeB magnetic powder and 9.40 wt % small particle NdFeB magnetic powder with 0.28 wt % silane coupling agent, followed by drying the solvent to obtain dried magnetic powder.

Mixing: the dried magnetic powder is mixed uniformly at room temperature with 2.74 wt % thermoplastic polyester elastomer, 0.68 wt % thermoplastic polyurethane elastomer, 0.50 wt % tetrakis(β(3,5-di-tert-butyl-4-hydroxyphenyl) propionate) pentaerythritol ester, 0.30 wt % wax emulsion, 0.50 wt % epoxy soybean oil, and 1.00 wt % dioctyl adipate using a high-speed mixer to obtain a mixed powder.

Preparation of feedstock: the mixed powder is mixed and pelletized by using a twin-screw extruder, which includes 9 mixing sections, with a maximum mixing temperature of 170° C. and a minimum mixing temperature of 140° C., to obtain feedstock for injection molding.

Injection molding: the feedstock is injected molded using an injection molding machine, which has 5 temperature zones, with a maximum temperature of 190° C. and a minimum temperature of 170° C.

### Example III

Preparation process of the NdFeB flexible magnet in the present disclosure is as follow.

Magnetic powder pretreatment: surface treatment of 85.10 wt % large particle NdFeB magnetic powder and 9.46 wt % small particle NdFeB magnetic powder with 0.28 wt % silane coupling agent, followed by drying the solvent to obtain dried magnetic powder.

Mixing: the dried magnetic powder is uniformly mixed at room temperature using a high-speed mixer with 2.29 wt % thermoplastic polyester elastomer, 0.57 wt % thermoplastic polyurethane elastomer, 0.50 wt % tetrakis(β(3,5-di-tert-butyl-4-hydroxyphenyl)propionate) pentaerythritol ester, 0.30 wt % wax emulsion, 0.50 wt % epoxidized soybean oil, and 1.00 wt % dioctyl adipate to obtain a mixed powder.

Preparation of feedstock: the mixed powder is mixed and pelletized by using a twin-screw extruder, which includes 9 mixing sections, with a maximum mixing temperature of 170° C. and a minimum mixing temperature of 140° C., to obtain feedstock for injection molding.

Injection molding: the feedstock is injected molded using an injection molding machine, which has 5 temperature zones, with a maximum temperature of 190° C. and a minimum temperature of 170° C.

### Example IV

Preparation process of the NdFeB flexible magnet in the present disclosure is as follow.

Magnetic powder pretreatment: surface treatment of 84.50 wt % large particle NdFeB magnetic powder and 9.39 wt % small particle NdFeB magnetic powder with 0.47 wt % silane coupling agent, followed by drying the solvent to obtain dried magnetic powder.

Mixing: the dried magnetic powder is uniformly mixed at room temperature using a high-speed mixer with 2.67 wt % thermoplastic polyolefin elastomer, 0.67 wt % thermoplastic polyamide elastomer, 1.0 wt % 2,6-di-tert-butyl-4-methylphenol, 0.30 wt % silicone oil, 0.50 wt % epoxidized soybean oil, and 0.50 wt % dioctyl phthalate to obtain a mixed powder.

Preparation of feedstock: the mixed powder is mixed and pelletized by using a twin-screw extruder, which includes 9 mixing sections, with a maximum mixing temperature of 170° C. and a minimum mixing temperature of 140° C., to obtain feedstock for injection molding.

Injection molding: the feedstock is injected molded using an injection molding machine, which has 5 temperature zones, with a maximum temperature of 190° C. and a minimum temperature of 170° C.

### Example V

Preparation process of the NdFeB flexible magnet in the present disclosure is as follow.

Magnetic powder pretreatment: surface treatment of 93.74 wt % large particle NdFeB magnetic powder with 0.28 wt % silane coupling agent, followed by drying the solvent to obtain dried magnetic powder.

Mixing: the dried magnetic powder is uniformly mixed at room temperature using a high-speed mixer with 3.11 wt % polystyrene-poly(ethylene-butylene)-polystyrene block copolymer, 2.07 wt % thermoplastic polyamide elastomer, 0.3 wt % N,N′-bis(3-(3,5-di-tert-butyl-4-hydroxyphenyl)propionyl)hydrazine, and 0.50 wt % dioctyl adipate to obtain a mixed powder.

Preparation of feedstock: the mixed powder is mixed and pelletized by using a twin-screw extruder, which includes 9 mixing sections, with a maximum mixing temperature of 170° C. and a minimum mixing temperature of 140° C., to obtain feedstock for injection molding

Injection molding: the feedstock is injected molded using an injection molding machine, which has 5 temperature zones, with a maximum temperature of 190° C. and a minimum temperature of 170° C.

### Example VI

Preparation process of the NdFeB flexible magnet in the present disclosure is as follow.

Magnetic powder pretreatment: surface treatment of 65.84 wt % large particle NdFeB magnetic powder and 28.22 wt % small particle NdFeB magnetic powder with 0.28 wt % silane coupling agent, followed by drying the solvent to obtain dried magnetic powder.

Mixing: the dried magnetic powder is uniformly mixed at room temperature using a high-speed mixer with 3.36 wt % thermoplastic polyester elastomer, 0.5 wt % pentaerythritol tetrakis(β-(3,5-di-tert-butyl-4-hydroxyphenyl)propionate), 0.3 wt % wax emulsion, 0.5 wt % epoxidized soybean oil, and 1 wt % dioctyl adipate to obtain a mixed powder.

Preparation of feedstock: the mixed powder is mixed and pelletized by using a twin-screw extruder, which includes 9 mixing sections, with a maximum mixing temperature of 170° C. and a minimum mixing temperature of 140° C., to obtain feedstock for injection molding.

Injection Molding: the feedstock is injected molded using an injection molding machine, which has 5 temperature zones, with a maximum temperature of 190° C. and a minimum temperature of 170° C.

### Example VII

Preparation process of the NdFeB flexible magnet in the present disclosure is as follow.

Magnetic powder pretreatment: surface treatment of 84.61 wt % large particle NdFeB magnetic powder and 9.4 wt % small particle NdFeB magnetic powder with 0.28 wt % silane coupling agent, followed by drying the solvent to obtain dried magnetic powder.

Mixing: the dried magnetic powder is uniformly mixed at room temperature using a high-speed mixer with 3.07 wt % thermoplastic polyester elastomer, 0.34 wt % thermoplastic polyurethane elastomer, 0.5 wt % pentaerythritol tetrakis(β-(3,5-di-tert-butyl-4-hydroxyphenyl)propionate), 0.3 wt % wax emulsion, 0.5 wt % epoxidized soybean oil, and 1 wt % dioctyl adipate to obtain a mixed powder.

Preparation of feedstock: the mixed powder is mixed and pelletized by using a twin-screw extruder, which includes 9 mixing sections, with a maximum mixing temperature of 170° C. and a minimum mixing temperature of 140° C., to obtain feedstock for injection molding.

Injection Molding: the feedstock is injected molded using an injection molding machine, which has 5 temperature zones, with a maximum temperature of 190° C. and a minimum temperature of 170° C.

### Example VIII

Preparation process of the NdFeB flexible magnet in the present disclosure is as follow.

Magnetic powder pretreatment: surface treatment of 75.19 wt % large particle NdFeB magnetic powder and 18.8 wt % small particle NdFeB magnetic powder with 0.28 wt % silane coupling agent, followed by drying the solvent to obtain dried magnetic powder.

Mixing: the dried magnetic powder is uniformly mixed at room temperature using a high-speed mixer with 2.47 wt % thermoplastic polyester elastomer, 0.69 wt % thermoplastic polyurethane elastomer, 0.5 wt % pentaerythritol tetrakis(β-(3,5-di-tert-butyl-4-hydroxyphenyl)propionate), 0.3 wt % wax emulsion, 0.5 wt % epoxidized soybean oil, and 1 wt % dioctyl adipate to obtain a mixed powder.

Preparation of feedstock: the mixed powder is mixed and pelletized by using a twin-screw extruder, which includes 9 mixing sections, with a maximum mixing temperature of 170° C. and a minimum mixing temperature of 140° C., to obtain feedstock for injection molding.

Injection Molding: the feedstock is injected molded using an injection molding machine, which has 5 temperature zones, with a maximum temperature of 190° C. and a minimum temperature of 170° C.

### Example VIIII

Preparation process of the NdFeB flexible magnet in the present disclosure is as follow.

Magnetic powder pretreatment: surface treatment of 56.4 wt % large particle NdFeB magnetic powder and 37.6 wt % small particle NdFeB magnetic powder with 0.28 wt % silane coupling agent, followed by drying the solvent to obtain dried magnetic powder.

Mixing: the dried magnetic powder is uniformly mixed at room temperature using a high-speed mixer with 2.74 wt % thermoplastic polyester elastomer, 0.68 wt % thermoplastic polyurethane elastomer, 0.50 wt % pentaerythritol tetrakis(β-(3,5-di-tert-butyl-4-hydroxyphenyl)propionate), 0.30 wt % wax emulsion, 0.50 wt % epoxidized soybean oil, and 1.00 wt % dioctyl adipate to obtain a mixed powder.

Preparation of feedstock: the mixed powder is mixed and pelletized by using a twin-screw extruder, which includes 9 mixing sections, with a maximum mixing temperature of 170° C. and a minimum mixing temperature of 140° C., to obtain feedstock for injection molding.

Injection Molding: the feedstock is injected molded using an injection molding machine, which has 5 temperature zones, with a maximum temperature of 190° C. and a minimum temperature of 170° C.

### Comparative Example I

Preparation process of a neodymium-iron-boron flexible magnet is as follow.

The preparation process is the same as example, with the following differences: 0.28 wt % silane coupling agent is used to treat the surface of 94.00 wt % large particle size neodymium-iron-boron magnetic powder, after drying the solvent, the dried magnetic powder is obtained and this powder is then mixed uniformly at room temperature using a high-speed mixer with 3.42 wt % thermoplastic polyester elastomer, 0.50 wt % pentaerythritol tetrakis(β-(3,5-di-tert-butyl-4-hydroxyphenyl)propionate), 0.30 wt % wax emulsion, 0.50 wt % epoxidized soybean oil, and 1.00 wt % dioctyl adipate to obtain a mixed powder.

### Comparative Example III

Preparation process of a neodymium-iron-boron flexible magnet is as follow.

The preparation process is the same as example, with the following differences: 0.28 wt % silane coupling agent is used to treat the surface of 84.64 wt % large particle size neodymium-iron-boron magnetic powder and 9.4 wt % small particle size neodymium-iron-boron magnetic powder, after drying the solvent, the dried magnetic powder is obtained and this powder is then mixed uniformly at room temperature using a high-speed mixer with 3.38 wt % thermoplastic polyester elastomer, 0.5 wt % pentaerythritol tetrakis(β-(3,5-di-tert-butyl-4-hydroxyphenyl)propionate), 0.3 wt % wax emulsion, 0.5 wt % epoxidized soybean oil, and 1 wt % dioctyl adipate to obtain a mixed powder.

### Comparative Example IV

Preparation process of a neodymium-iron-boron flexible magnet is as follow.

The preparation process is the same as example, with the following differences: 0.28 wt % silane coupling agent is used to treat the surface of 83.5 wt % large particle size neodymium-iron-boron magnetic powder and 9.28 wt % small particle size neodymium-iron-boron magnetic powder, after drying the solvent, the dried magnetic powder is obtained and this powder is then mixed uniformly at room temperature using a high-speed mixer with 4.18 wt % thermoplastic polyester elastomer, 0.46 wt % thermoplastic polyurethane elastomer, 0.5 wt % pentaerythritol tetrakis(β-(3,5-di-tert-butyl-4-hydroxyphenyl)propionate), 0.3 wt % wax emulsion, 0.5 wt % epoxidized soybean oil, and 1 wt % dioctyl adipate to obtain a mixed powder.

### Comparative Example V

Preparation process of a neodymium-iron-boron flexible magnet is as follow.

The preparation process is the same as example, with the following differences: 0.28 wt % silane coupling agent is used to treat the surface of 89.19 wt % large particle size neodymium-iron-boron magnetic powder and 4.69 wt % small particle size neodymium-iron-boron magnetic powder, after drying the solvent, the dried magnetic powder is obtained and this powder is then mixed uniformly at room temperature using a high-speed mixer with 1.77 wt % thermoplastic polyester elastomer, 1.77 wt % thermoplastic polyurethane elastomer, 0.5 wt % pentaerythritol tetrakis(β-(3,5-di-tert-butyl-4-hydroxyphenyl)propionate), 0.3 wt % wax emulsion, 0.5 wt % epoxidized soybean oil, and 1 wt % dioctyl adipate to obtain a mixed powder.

### Comparative Example VI

Preparation process of a neodymium-iron-boron flexible magnet is as follow.

The preparation process is the same as example, with the following differences: 0.28×silane coupling agent is used to treat the surface of 84.6 wt large particle size neodymium-iron-boron magnetic powder and 9.4 wt % small particle size neodymium-iron-boron magnetic powder, after drying the solvent, the dried magnetic powder is obtained and this powder is then mixed uniformly at room temperature using a high-speed mixer with 3.09 wt % thermoplastic polyester elastomer, 0.33 wt % thermoplastic polyurethane elastomer, 0.5 wt % pentaerythritol tetrakis(β-(3,5-di-tert-butyl-4-hydroxyphenyl)propionate), 0.3 wt % wax emulsion, 0.5 wt % epoxidized soybean oil, and 1 wt % dioctyl adipate to obtain a mixed powder.

### Experimental Example

Test the particle characteristics of the above implementation examples and the control sample. Testing conditions: 170° C., load 10 kg. The results are shown in Table 2.

TABLE 2

| | Melt volume | Melt flow | | Melt volume | Melt flow |
|---|---|---|---|---|---|
| | rate/MVR | rate/MFR | | rate/MVR | rate/MFR |
| | (cm³/10 min) | (g/10 min) | | (cm³/10 min) | (g/10 min) |
| Example I | 20.1 | 110 | Comparative | 2.5 | 14 |
| | | | Example I | | |
| Example II | 36.5 | 202 | Comparative | 127.6 | 706 |
| | | | Example II | | |
| Example III | 15.3 | 87 | Comparative | 20.0 | 110 |
| | | | Example III | | |
| Example IV | 18.2 | 101 | Comparative | 34 | 178 |
| | | | Example IV | | |
| Example V | 23.5 | 130 | Comparative | 83.5 | 459 |
| | | | Example V | | |
| Example VI | 51.2 | 282 | Comparative | 21.3 | 117 |
| | | | Example VI | | |
| Example VII | 33.2 | 183 | / | / | / |
| Example VIII | 38.4 | 212 | / | | / |
| Example VIIII | 63.1 | 348 | / | / | / |

According to the data in Table 2, comparing Example I with Comparative Example I, the use of the two-component resin (binder) in this application increases the melt volume rate (MVR) of the feedstock from 2.5 cm³/10 min to 20.1 cm³/10 min, and the melt flow rate (MFR) from 14 g/10 min to 110 g/10 min (testing temperature 170° C., load 10 kg).

Comparing Example II with Comparative Example II, the use of the size-graded compounded two-component magnetic powder in this application increases the melt volume rate (MVR) of the feedstock from 20 cm³/10 min to 36.5 cm³/10 min, and the melt flow rate (MFR) from 110 g/10 min to 202 g/10 min (testing temperature 170° C., load 10 kg).

Comparing Example III with Comparative Example III, the use of the size-graded compounded two-component magnetic powder in this application can increase the magnetic powder filling ratio to 94.56 wt %, while still maintaining the melt volume rate (MVR) of the feedstock at 15.3 cm³/10 min and the melt flow rate (MFR) at 87 g/10 min.

The TPE-type neodymium iron boron feedstock prepared in Comparative Sample I has a melt volume rate (MVR) of only 2.5 cm³/10 min (testing temperature 170° C., load 10 kg), while the TPE-type neodymium iron boron feedstock prepared in Comparative Sample II has a melt volume rate (MVR) as high as 127.6 cm³/10 min (testing temperature 170° C., load 10 kg). However, the high-flow TPE-type neodymium iron boron feedstock exhibits relatively poor strength and toughness. On the other hand, TPE-type neodymium iron boron feedstock that meet the requirements for strength and toughness tend to have poor flowability, making them unsuitable for injection molding.

The feedstock prepared from the implementation examples and comparative examples were subjected to injection molding using an injection molding machine, and the characteristics of the molded samples were tested.

Characterization Methods are as follows:

Flexural Strength: long strip samples measuring 80 mm×10 mm×4 mm were molded and tested for flexural strength according to the standards ISO 178-2019 or GB/T 9341-2000, with a flexural strength of greater than or equal to 4.5 MPa considered favorable.

Column Wrapping Test: long strip samples measuring 80 mm×10 mm×1 mm were molded and tightly wrapped around a cylinder with a cross-sectional diameter of D25 mm, (18 mm, Φ14 mm, or Φ10 mm, with a length of 150 mm to 200 mm. The samples were examined for any cracks. The best outcome is achieved when the sample can be tightly wrapped around a cylinder with a cross-sectional diameter of Φ10 mm without cracking or visible defects.

Tensile Strength (ISO 527-1,2): tensile strength tests were conducted according to the standard GB/T 1040.2-2006 (i.e., ISO 527-2:1993). Dumbbell-shaped tensile samples were molded, and their tensile strength (in MPa) and elongation at break (in %) were tested using a universal testing machine.

High-Temperature Demagnetization under Humid Heat Conditions: standard samples measuring (10 mm×(8-10) mm were molded. These samples were treated in a humid heat oven at 65° C. and 90% humidity for 72 hours. The changes in magnetic flux of the magnets before and after humid heat exposure were observed, along with any signs of rust, cracking, or powdering.

The molded sample dimensions included (10 mm×10 mm, 80 mm×10 mm×4 mm, and 80 mm×10 mm×1 mm. The injection molding temperature ranged from 170° C. to 190° C., with the molding conditions detailed in Table 3. The test results for the characteristics of the injection-molded samples are shown in Table 4.

TABLE 3
Injection Molding Temperature Gradient

| | | | | | Mold |
|---|---|---|---|---|---|
| Stage 1 | Stage 2 | Stage 3 | Stage 4 | Stage 5 | Temperature |
| 190° C. | 190° C. | 190° C. | 180° C. | 170° C. | 30° C. |

TABLE 4
Characteristic Parameters of Injection Molding Samples in Examples

| Characteristic | | Example | Example | Example | Example | Example | Example | Example | Example | Example |
|---|---|---|---|---|---|---|---|---|---|---|
| parameters | Unit | I | II | III | IV | V | VI | VII | VIII | VIII |
| Remanence (Br) | Gs | 6392 | 6405 | 6576 | 6246 | 6221 | 6027 | 6148 | 6230 | 6011 |
| Coercivity (Hcb) | Oe | 5424 | 5467 | 5478 | 5353 | 5276 | 5024 | 5070 | 5179 | 5064 |
| Intrinsic | Oe | 9514 | 9504 | 9424 | 9330 | 9354 | 9391 | 9310 | 9367 | 9273 |
| coercivity (Hcj) | | | | | | | | | | |
| Maximum magnetic | MGOe | 8.659 | 8.791 | 9.002 | 8.358 | 8.217 | 7.675 | 7.847 | 8.174 | 7.655 |
| energy product | | | | | | | | | | |
| ((BH)max) | | | | | | | | | | |
| Density | g/cm³ | 5.44 | 5.49 | 5.68 | 5.50 | 5.49 | 5.50 | 5.48 | 5.5 | 5.49 |
| Bending Strength | MPa | 6.1 | 4.5 | 4.2 | 4.4 | 3.5 | 3.9 | 4.6 | 4.6 | 3.8 |
| Tensile Strength | MPa | 4.00 | 3.98 | 3.68 | 3.87 | 3.20 | 3.64 | 3.99 | 4.01 | 3.6 |
| High-Temperature | % | −1.27 | −1.13 | −1.24 | −1.21 | −1.18 | −1.23 | −1.18 | −1.21 | −1.28 |
| Demagnetization | | | | | | | | | | |
| under Humid | | | | | | | | | | |
| Conditions | | | | | | | | | | |
| Minimum Cylinder | mm | 10 | 10 | 14 | 10 | 14 | 14 | 10 | 10 | 14 |
| Diameter for One | | | | | | | | | | |
| Wrap | | | | | | | | | | |

TABLE 5
Characteristic Parameters of Injection Molding Samples in Comparative Examples

| Characteristic | | Comparative | Comparative | Comparative | Comparative | Comparative | Comparative |
|---|---|---|---|---|---|---|---|
| parameters | Unit | Example I | Example II | Example III | Example IV | Example V | Example VI |
| Remanence (Br) | Gs | / | / | 6126 | 5866 | / | 6020 |
| Coercivity (Hcb) | Oe | / | / | 5125 | 4891 | / | 5116 |
| Intrinsic | Oe | / | / | 9347 | 9301 | / | 9392 |
| coercivity (Hcj) | | | | | | | |
| Maximum magnetic | MGOe | / | / | 7.95 | 7.241 | / | 7.821 |
| energy product | | | | | | | |
| ((BH)max) | | | | | | | |
| Density | g/cm³ | / | / | 5.48 | 5.2 | / | 5.5 |
| Bending Strength | MPa | / | / | 3 | 5.9 | / | 3.2 |
| Tensile Strength | MPa | / | / | 4.13 | 3.99 | / | 3.81 |
| High-Temperature | % | / | / | −1.2 | −1.23 | / | −1.15 |
| Demagnetization | | | | | | | |
| under Humid | | | | | | | |
| Conditions | | | | | | | |
| Minimum Cylinder | mm | Failing | Failing | 18 | 10 | Failing | 18 |
| Diameter for One | | | | | | | |
| Wrap | | | | | | | |

Based on the characteristics data of the injection-molded samples in the above table, it can be seen that the flowability of the feedstocks for Comparative Example I, Comparative Example II, and Comparative Example V is poor, making injection molding unfeasible. Although Comparative Example III and Comparative Example IV can be injection molded to produce magnets, these magnets exhibit poor flexibility, with the minimum cylindrical diameter that can be wrapped being only 18 mm. Comparative Example IV, while both capable of injection molding and possessing good flexibility, has a maximum magnetic energy product of only 7.241 MGOe.

In comparison, the feedstock in the examples of this application exhibit better flowability, and the magnets produced show excellent performance in terms of filling density, flexibility, bending strength, and tensile strength, with the maximum magnetic energy product reaching as high as 9.002 MGOe.

The description of the above embodiments is intended to aid in understanding the methods and core concepts of this application. It should be noted that for those skilled in the art, various modifications and alterations can be made to this application without departing from the principles herein, and such modifications and alterations also fall within the scope of the claims of this application.

1. A neodymium-iron-boron flexible magnet comprising:
neodymium-iron-boron magnetic powder with a content in a range from 93.5 wt % to 94.6 wt %;
surface treatment agent for magnetic powder with a content in a range from 0.3 wt % to 0.5 wt %;
binder with a content in a range from 2.7 wt % to 3.7 wt %;
antioxidant with a content in a range from 0.3 wt % to 1.0 wt %; and
plasticizer with a content in a range from 0.5 wt % to 1.8 wt %;
wherein:
the binder includes type I thermoplastic elastomer and type II thermoplastic elastomer, with a mass ratio of the type I thermoplastic elastomer to the type II thermoplastic elastomer being 1:9 to 4:6;
the type I thermoplastic elastomer is selected from one or more of thermoplastic polyamide elastomer and thermoplastic polyurethane elastomer; and
the type II thermoplastic elastomer is selected from one or more of styrenic block copolymers, dynamically vulcanized thermoplastic elastomers, thermoplastic polyolefin elastomers, and thermoplastic polyester elastomers.

2. The neodymium-iron-boron flexible magnet according to claim 1, wherein the neodymium-iron-boron magnetic powder has a particle size D50 value in a range from 50 μm to 100 μm.

3. The neodymium-iron-boron flexible magnet according to claim 1, wherein the neodymium-iron-boron magnetic powder includes:
a rare earth metal element with a content in a range from 20 wt % to 26 wt %;
element M with a content in a range from 0 wt % to 2.5 wt %, M being a transition metal element other than Fe and Co;
Co with a content in a range from 0 wt % to 5 wt %;
B with a content in a range from 0.98 wt % to 1.1 wt %; and
Fe.

4. The neodymium-iron-boron flexible magnet according to claim 3, wherein M is one or more selected from Cu, Zr, Nb, Ti, Cr, V, Mo, and W.

5. The neodymium-iron-boron flexible magnet according to claim 2, further comprising:
compound magnetic powder having a particle size D50 value in a range from 2 μm to 20 μm;
wherein the compound magnetic powder is selected from NdFeB compound magnetic powder, SmFeN compound magnetic powder, or ferrite compound powder.

6. The neodymium-iron-boron flexible magnet according to claim 5, wherein a mass ratio of the neodymium-iron-boron magnetic powder to the compound magnetic powder is in a range from 9:1 to 7:3.

7. The neodymium-iron-boron flexible magnet according to claim 5, wherein the compound magnetic powder is the NdFeB compound magnetic powder including:
a rare earth metal element with a content in a range from 20 wt % to 26 wt %;
element M with a content in a range from 0 wt % to 2.5 wt %, M being a transition metal element other than Fe and Co;
Co with a content in a range from 0 wt % to 5 wt %;
B with a content in a range from 0.98 wt % to 1.1 wt %; and
Fe.

8. The neodymium-iron-boron flexible magnet according to claim 7, wherein M is one or more selected from Cu, Zr, Nb, Ti, Cr, V, Mo, and W.

9. The neodymium-iron-boron flexible magnet according to claim 1, wherein:
the styrenic block copolymers include polystyrene-polybutadiene-polystyrene block copolymer, polystyrene-poly(ethylene-butylene)-polystyrene block copolymer, polystyrene-poly(ethylene-propylene)-polystyrene block copolymer, and polystyrene-polyisoprene-polystyrene block copolymer; and
the dynamically vulcanized thermoplastic elastomers include blends of ethylene-propylene rubber and polypropylene, blends of nitrile rubber and polypropylene, or blends of diene rubber and thermoplastic vulcanizates of polyolefin.

10. The neodymium-iron-boron flexible magnet according to claim 1, wherein:
the surface treatment agent is selected from one or more of silane coupling agents, titanate coupling agents, aluminate coupling agents, phosphates, phosphonates, and nano-silica;
the plasticizer is one or more selected from natural wax, synthetic wax, fatty acid metal salts, silicon dioxide compounds, polysiloxanes, fluoroplastics, epoxidized soybean oil, silicone oil, phthalates, phosphate esters, adipate esters, sebacic esters, and decanoate esters, citrate esters, trimellitate esters, halogenated hydrocarbons, benzoate esters, fatty acid esters, pentaerythritol, epoxidized fatty esters, and polyesters; and
the antioxidant is one or more selected from hindered amine antioxidants, hindered phenolic antioxidants, phosphites, or thioesters.

11. The neodymium-iron-boron flexible magnet according to claim 1, wherein a maximum magnetic energy product of the neodymium-iron-boron flexible magnet is equal to or greater than 7.5 MGOe.

12. A method of preparing the neodymium-iron-boron flexible magnet according to claim 1, comprising:
surface treating and drying the neodymium-iron-boron magnetic powder to obtain dried neodymium-iron-boron magnetic powder;
uniformly mixing the dried neodymium-iron-boron magnetic powder with the binder, the antioxidant, and the plasticizer to obtain a mixed powder;
performing raw material mixing to obtain feedstock; and
injection molding the feedstock to produce the neodymium-iron-boron flexible magnet.

13. The method according to claim 12, wherein:
the raw material mixing is performed using a twin-screw extruder including 9 mixing sections and at a mixing temperature in a range of 140° C. to 170° C.; and
the injection molding is performed using an injection molding machine including 5 temperature zones and at an injection temperature in a range of 170° C. to 190° C.

14. A feedstock for preparing neodymium-iron-boron flexible magnet comprising:
neodymium-iron-boron magnetic powder with a content in a range from 93.5 wt % to 94.6 wt %;
surface treatment agent for magnetic powder with a content in a range from 0.3 wt % to 0.5 wt %;
binder with a content in a range from 2.7 wt % to 3.7 wt %;
antioxidant with a content in a range from 0.3 wt % to 1.0 wt %; and
plasticizer with a content in a range from 0.5 wt % to 1.8 wt %;
wherein:
the binder includes type I thermoplastic elastomer and type II thermoplastic elastomer, with a mass ratio of the type I thermoplastic elastomer to the type II thermoplastic elastomer in a range of 1:9 to 4:6;
the type I thermoplastic elastomer is selected from one or more of thermoplastic polyamide elastomer and thermoplastic polyurethane elastomer;
the type II thermoplastic elastomer is selected from one or more of styrenic block copolymers, dynamically vulcanized thermoplastic elastomers, thermoplastic polyolefin elastomers, and thermoplastic polyester elastomers; and
under a load of 10 kg at 170° C., the feedstock has a melt volume rate (MVR) in a range from 15 cm³/10 min to 65 cm³/10 min or a melt flow rate (MFR) in a range from 80 g/10 min to 350 g/10 min.

15. The feedstock according to claim 14, wherein the neodymium-iron-boron magnetic powder has a particle size D50 value in a range from 50 μm to 100 μm.

16. The feedstock according to claim 15, further comprising:
compound magnetic powder having a particle size D50 value in a range from 2 μm to 20 μm;
wherein:
the compound magnetic powder is selected from NdFeB compound magnetic powder, SmFeN compound magnetic powder, or ferrite compound powder; and
a mass ratio of the neodymium-iron-boron magnetic powder to the compound magnetic powder is in a range from 9:1 to 7:3.
